(19) United States
(12) Patent Application Publication
(10) Pub. No.: US 2016/0182657 A1
(43) Pub. Date: Jun. 23, 2016

(54) APPARATUS AND METHOD OF USER IDENTIFICATION ACROSS MULTIPLE DEVICES

(71) Applicant: ShareThis, Inc., Palo Alto, CA (US)

(72) Inventors: Saikat MUKHERJEE, Fremont, CA (US); Juan VALENCIA, East Palo Alto, CA (US); Yan QU, Los Altos, CA (US); Nanda KISHORE, Los Altos, CA (US); Ishika PAUL, Mountain View, CA (US); Kalpak SHAH, Palo Alto, CA (US); Iosefa Maria Carmen MAIEREAN, Sunnyvale, CA (US); Allen FUNG, Campbell, CA (US)

(73) Assignee: SHARETHIS, INC., Palo Alto, CA (US)

(21) Appl. No.: 14/573,957

(22) Filed: Dec. 17, 2014

(51) Int. Cl. H04L 29/08; H04L 12/26

(52) U.S. Cl. CPC H04L 67/22; H04L 43/04; H04L 67/16

(57) ABSTRACT

A method and apparatus capable of identifying a unique user across multiple devices in a computer network are provided. Device-specific and behavioral features associated with an event and a device are extracted. The device-specific features form a device signature associated the device. Hardware mobile device identifiers (IDs) are also associated with mobile application devices. Over a period of time, the behavioral features of such devices are monitored. Similarity scores between various devices are calculated based on the behavioral features and device types. The devices in the computer network are clustered and a device graph is generated representing the connections between the devices based on the similarity scores. A unique user ID associated with the multiple devices is generated from the device graph.

### BACKGROUND

1. Field

Apparatuses and methods consistent with the exemplary embodiments relate to online advertising. More particularly, apparatuses and methods consistent with the exemplary embodiments are related to identifying a unique user associated with multiple devices in a computer network.

2. Description of the Related Art

Over the years, the use of the Internet has risen. In the recent past, the Internet as a platform for commercial activities has gained popularity. One of the major reasons of increased use of the Internet is its easy accessibility by way of improved infrastructure and a wide range of devices to access it. A user is no longer connected to the Internet only via a personal computer or a laptop device. The evolution of the smartphone and tablet industries allows the user to access the Internet on the go by way of smartphone and tablet devices as well.

With the growth of the Internet, the online advertising sector has seen a major boom. Nowadays, online advertising is one of the major media of advertising products and services for various companies. To take advantage of this medium, it is essential to target the right audience segment with advertisements. The right audience segment is identified by tracking activities of users in the computer network over a period of time and understanding their interests. However, as a user may use multiple devices for different purposes, online advertisers may miss a few devices of the user to provide advertisements. Therefore, it is extremely crucial to identify a unique user across multiple devices, such as one or more personal computers, laptops, smartphones and tablets, and track his/her online activity to target the user with relevant advertisements. Further, identification of a unique user also provides useful insights related to his/her online activity and behavior across multiple devices.

To simplify the method of identifying a unique user, the aforementioned devices are categorized as desktop web, mobile web, and mobile application (app) devices. The desktop web devices include personal computers and laptops. The mobile web and app devices include smartphones and tablets. When the Internet is accessed using browsers on smartphones and tablets, the smartphones and the tablets are referred to as mobile web devices. When an app accesses the Internet on smartphones and tablets without the need of a browser, the smartphones and the tablets are referred to as mobile app devices. Various methods exist to identify a user across these device types.

A common technique uses cookies that are stored on these devices. A cookie is a piece of data that is sent from a website and stored in the user's web browser operating in a desktop or a mobile web device. The cookie records and tracks the web browser activities, such as clicks, websites visited, time of the day, and the like. However, the use of cookies to identify unique users poses a number of limitations. A user may use one browser on the desktop web device and another browser on the mobile web device. Two different cookies are placed on the two devices to track the online user activity. Thus, two different cookies get associated with the same user. Similarly, when the same user accesses browsers on multiple devices, multiple cookies get associated with the user. Further, a user may reset his/her cookies that results in the cookie being deleted. Moreover, certain websites and browsers prevent setting of cookies. This phenomenon of cookies being deleted or expired is referred to as cookie churn. When a cookie is deleted or expires, all information associated therewith is lost. Thus, the cookie-based technique is not a persistent user identification technique and fails to identify a unique user across multiple devices. Moreover, as mobile apps do not allow cookies, online user activity on mobile app devices cannot be tracked using cookies. Device-specific identifiers such as ‘Identification for Advertisers’ (IDFA) in iOS™ and ‘Android ID’ in Android devices track the online user activity by tracking the app activity on the mobile app devices. Further, these identifiers are not associated to cookies.

An alternative method to cookies uses persistent device identifiers. The persistent device identifier technique identifies features such as Internet Protocol (IP) address, time zone, time difference offset, and the like that are associated with devices and uses this information to identify the devices. However, the persistent device identifier method only detects devices and does not link the devices to each other. In addition, the method is used only for desktop web and mobile web devices, and not for mobile app devices. Hence, the method fails to identify a unique user across multiple device types.

Smartphones and tablets include many apps that connect the user to the Internet. In such a scenario, the aforementioned methods that identify unique users across desktop web and mobile web devices fail and the online user activity of such a user on a mobile app device is not tracked. Specifically, to detect the online user activity of a user on mobile app devices, device-specific or hardware mobile device identifiers (IDs) such as the IDFA in iOS™ and the Android ID in Android devices are provided. Certain existing techniques in the art facilitate clustering of these hardware mobile device IDs based on shared features, such as a common household, or common behavioral characteristics amongst these devices. However, this technique is specific only to mobile app devices. A household has various users with multiple devices associated therewith. The household is connected to the Internet by way of a router that has a single IP address visible to the outsiders. The technique associates mobile app devices only to households and does not particularly identify multiple users across different devices within a household. Thus, when the mobile app devices are associated with only households, they are associated with only one IP address and hence, it becomes difficult to identify multiple users within the household.

Yet another solution is cross-device matching using non-persistent device identifiers. Cross-device matching technique matches mobile app devices to desktop or mobile web devices. In this technique, a cross-device table is generated that represents the associations of the mobile app devices and the desktop or mobile web devices. As this technique also uses cookies and hardware mobile device IDs to perform cross-device matching, the cross-device table is directly impacted by cookie churn. Further, the cross-device table provides the association of the cookies and the hardware mobile device IDs, and hence there may be multiple such associations corresponding to a single user. The cross-device table provides only a pairwise similarity score of the associated devices and does not link the devices to each other. Also, cross-device matching technique uses visitation and IP information, without taking into account any behavioral features of the devices such as time zone, domain, and the like. As no behavioral features of the devices are considered, it may not be possible to track all the user activities and there is possibility that the technique misses a few devices associated with the user. Hence, the cross-device table may not yield accurate results.

In light of the aforementioned drawbacks of existing techniques to identify unique users associated with multiple devices and multiple device types, it is desirable to provide a method and apparatus that accurately identify a unique user across all device types, thereby achieving better targeting of online advertisements to potential audience segments.

### SUMMARY

An aspect of an exemplary embodiment provides a method and apparatus for identifying a unique user associated with multiple devices and with multiple device types, in a computer network.

Another aspect of an exemplary embodiment provides a method and apparatus for achieving better targeting of online advertisements to potential audience segments.

An exemplary embodiment provides an apparatus for identifying a user associated with first and second devices of a plurality of devices in a network. The apparatus includes a memory and a processor. The memory stores behavioral features and at least one of a hardware identification (ID) and device signature features associated with a first event occurring at the first device, and behavioral features and at least one of a hardware ID and device signature features associated with a second event occurring at the second device. The processor is connected to the memory and includes a log parser, a persistent device identifier, a feature score determiner, an occurrence score determiner, a household_IP determiner, a device matcher, and a user-ID generator. The log parser fetches the behavioral features and at least one of the hardware ID and the device signature features associated with the first event occurring at the first device, and the behavioral features and at least one of the hardware ID and the device signature features associated with the second event occurring at the second device. The persistent device identifier generates first and second device signatures corresponding to the first and second devices based on the device signature features associated with the first and second events, respectively. The feature score determiner fetches the behavioral features associated with the first and second events and generating first and second sets of scores, respectively. The occurrence score determiner computes an occurrence score associated with at least one of the first and second device signatures and at least one of the hardware IDs associated with the first and second events based on Internet Protocol (IP) addresses of the first and second devices. The household_IP determiner determines whether at least one of the first and second device signatures and the hardware IDs associated with the first and second events are associated with a household IP address. The device matcher computes a matching score for at least one of the first and second device signatures and the hardware IDs associated with the first and second events based on the occurrence score and the behavioral features associated with the first and second events. The device matcher first computes the matching score for the devices within household IP addresses and subsequently for non-household IP address. Moreover, the device matcher specifically distinguishes between various device types (desktop, mobile web, mobile app) and matches them in distinct steps. The user-ID generator generates a device graph for representing a connection between at least one of the first and second device signatures and the hardware IDs associated with the first and second events based on the matching score, and generating a user ID associated with the first and second devices based on the connection therebetween, thereby associating the first and second devices with the user, wherein the user ID is stored in the memory.

Another exemplary embodiment provides a method for identifying a user associated with first and second devices of a plurality of devices in a network comprising the plurality of devices. Behavioral features and at least one of hardware ID and device signature features associated with a first event occurring at a first device, and behavioral features and at least one of hardware ID and device signature features associated with a second event occurring at a second device are fetched. First and second device signatures corresponding to the first and second devices based on the device signature features associated with the first and second events, respectively are generated. The behavioral features associated with the first and second events are fetched. First and second sets of scores corresponding to the behavioral features associated with the first and second events, respectively, are generated. An occurrence score associated with at least one of the first and second device signatures and at least one of the hardware IDs associated with the first and second events based on Internet Protocol (IP) addresses of the first and second devices are computed. At least one of the first and second device signatures and the hardware IDs associated with the first and second events associated with household IP address are determined. A matching score for at least one of the first and second device signatures and the hardware IDs associated with the first and second events based on the occurrence score and the behavioral features associated with the first and second events is computed. The matching score is computed based on the device types of the first and second devices and whether the first and second devices are within household IP addresses or across household IP addresses. A device graph for representing a connection between at least one of the first and second device signatures and the hardware IDs associated with the first and second events based on the matching score is generated. A user ID associated with the first and second devices based on the connection therebetween, thereby associating the first and second devices with the user is generated.

### BRIEF DESCRIPTION OF DRAWINGS

The features of the exemplary embodiments, which are believed to be novel, are set forth with particularity in the appended claims. Exemplary embodiments will hereinafter be described in conjunction with the appended drawings provided to illustrate and not to limit the scope of the claims, wherein like designations denote like elements, and in which:

FIG. 1 is a schematic diagram illustrating a computer environment in which various exemplary embodiments can be practiced;

FIG. 2 is a schematic block diagram illustrating a computer system that stores a set of instructions to perform one or more of the methodologies described herein, in accordance with various exemplary embodiments;

FIGS. 3A and 3B illustrate an example set of a feature value map for a device, in accordance with an exemplary embodiment;

FIG. 4 conceptually illustrates devices of four different users in a household, in accordance with an exemplary embodiment;

FIG. 5 is a diagram illustrating a device graph, in accordance with an exemplary embodiment; and

FIG. 6 is a flow chart illustrating a method of identifying a unique user across multiple devices, in accordance with an exemplary embodiment.

### DETAILED DESCRIPTION OF THE EXEMPLARY EMBODIMENTS

As used in the specification and claims, the singular forms “a”, “an” and “the” include plural references unless the context clearly dictates otherwise. For example, the term “an article” may include a plurality of articles unless the context clearly dictates otherwise.

Those with ordinary skill in the art will appreciate that the elements in the figures are illustrated for simplicity and clarity and are not necessarily drawn to scale. For example, the dimensions of some of the elements in the figures may be exaggerated, relative to other elements, in order to improve the understanding of the exemplary embodiments.

There may be additional components described in the foregoing application that are not depicted in one of the described drawings. In the event such a component is described, but not depicted in a drawing, the absence of such a drawing should not be considered as an omission of such design from the specification.

Before describing the exemplary embodiments in detail, it should be observed that the exemplary embodiments can utilize a computer-implemented method for identifying a unique user across multiple devices. Accordingly, the system components and the method steps have been represented where appropriate by conventional symbols in the drawings, showing only specific details that are pertinent for an understanding of the exemplary embodiments so as not to obscure the disclosure with details that will be readily apparent to those with ordinary skill in the art having the benefit of the description herein. While the specification concludes with the claims defining the features of the invention that are regarded as novel, it is believed that the invention will be better understood from a consideration of the following description in conjunction with the drawings, in which like reference numerals are carried forward.

Detailed exemplary embodiments are disclosed herein; however, it is to be understood that the disclosed exemplary embodiments are merely exemplary, and can be embodied in various forms. Therefore, specific structural and functional details disclosed herein are not to be interpreted as limiting, but merely as a basis for the claims and as a representative basis for teaching one skilled in the art to variously employ the exemplary embodiment in virtually any appropriately detailed structure. Further, the terms and phrases used herein are not intended to be limiting but rather to provide an understandable description of the invention.

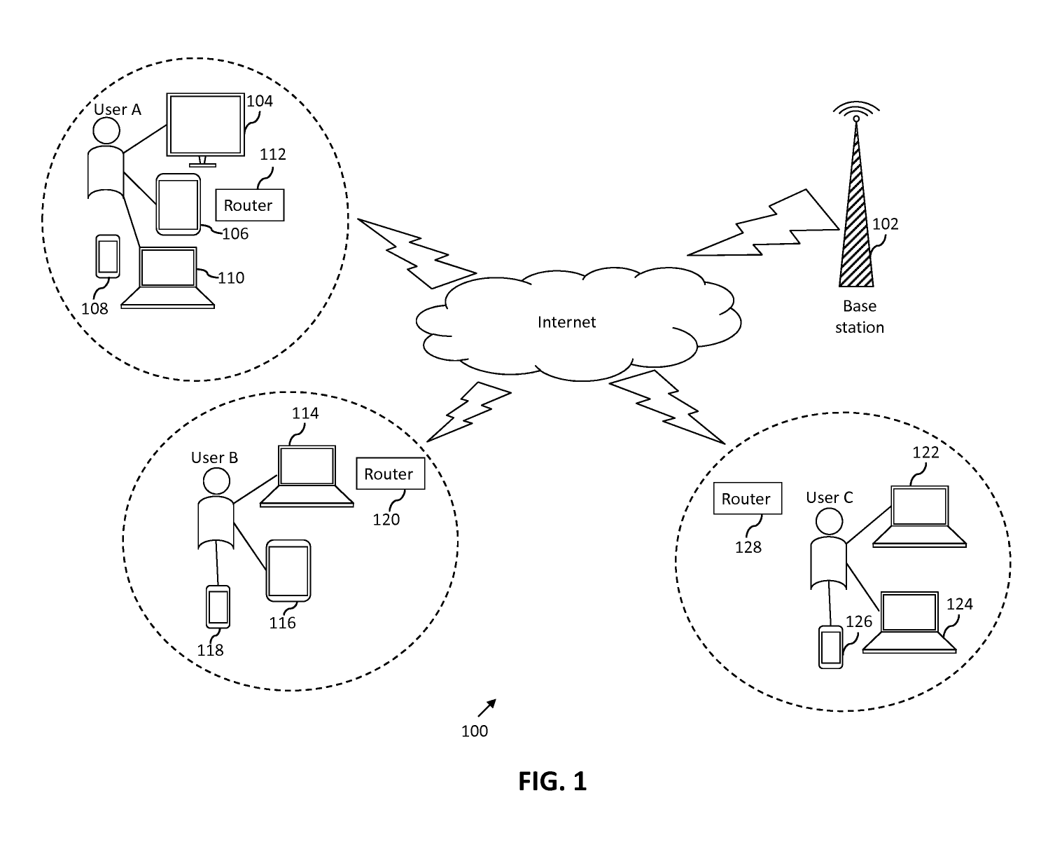

Referring now to FIG. 1, a schematic diagram illustrating an environment 100 in which various exemplary embodiments are practiced is shown. The environment 100 illustrates three users: user A, user B, and user C, and a base station 102. The base station 102 provides a cellular network to devices such as smartphones and tablets that are owned and used by the users. In illustrative exemplary embodiments, the user A has a personal computer 104, a tablet 106, a smartphone 108, and a laptop 110. These devices may be connected to the Internet by way of a router 112 or the cellular network provided by the base station 102. The personal computer 104 and the laptop 110 are connected to the Internet by way of the router 112. Further, the personal computer 104 may be connected to the router 112, the tablet 106, the smartphone 108 or the laptop 110 wirelessly by using a dongle to add Internet streaming functionality to the personal computer 104. The user A may choose to connect the smartphone and the tablet 106 and 108 to the Internet by way of the router 112 or the cellular network. Similarly the user B uses a laptop 114, a tablet 116, and a smartphone 118 that may be connected to the Internet by way of a router 120. The laptop 114, the tablet 116, and the smartphone 118 may also be connected to the Internet by way of the cellular network. The user B creates a portable Wi-Fi hotspot through one of the smartphone 118 or the tablet 116 and connects the laptop 114 to the portable Wi-Fi hotspot to access the Internet. The user C has two laptops 122 (work laptop) and 124 (personal laptop), and a smartphone 126. As described earlier the user C may also connect the laptops 122 and 124 and the smartphone 126 to the Internet by way of a router 128 or the cellular network. It should be noted that while three users are shown for illustration, the system of the exemplary embodiments works with any number of users that use various devices. To describe the exemplary embodiments in greater detail, a few terms are defined below:

Event: An event is an action performed by a user on various websites or in mobile applications (apps). The event is also referred to as a user activity. Examples of events include, but are not limited to, sharing through a tracking component such as a widget, a button, a social optimizing pixel, a retargeting pixel, a hypertext, a HyperText Markup Language (HTML) tag, and a link, viewing a web page, clicking a web link, visiting a web page, searching for a keyword, navigating within an app, etc. The actions could be either social, where the user shares a Universal Resource Link (URL) to social networks or clicks back to the URL from a social network, or non-social such as a regular page view or landing on the URL through search engines.

Device: A device is either a desktop web device or a mobile web or a mobile application (app) device. Devices such as personal computers, Chromebooks, and laptops that use browsers are categorized as desktop web devices. When browsers are used on smartphones and tablets, the smartphones and the tablets are referred to as mobile web devices. When the Internet is accessed using apps on smartphones and tablets, the smartphones and the tablets are referred to as mobile app devices. The mobile app devices have device-specific identifiers known as the advertising identifiers (IDs) (hereinafter referred to as “hardware mobile device IDs”) such as IDFA and Android IDs. These hardware mobile device IDs are received in ad requests within mobile apps or from event logs of the apps.

User: A user is an entity associated with a collection of different kinds of devices. The user may be associated with multiple desktop and mobile devices. Some of these devices are only browser based, such as desktops and laptops, and some have both web as well as apps such as smartphones and tablets.

Device-specific features: Device-specific features include various attributes associated with a device. The device-specific features may be one or more of, but not limited to, browser type, operating system (OS) type, browser fonts, browser plugins, device screen resolution, browser time zone, Internet Protocol (IP) address where an event happens, location (such as city/state or designated market area (DMA) or latitude/longitude) where the event happens. These features are extracted from browser characteristics, device characteristics, location, and IP address.

Behavioral features: Behavioral features include attributes associated with an event that occurs at a device. The behavioral features may be one or more of, but not limited to, domains (e.g. com, info, net, edu, org, and country code top-level domains), social channels (e.g. Facebook™, Twitter™, LinkedIn™, etc.), time of the day, day of the week, categories of a web page (e.g. news, entertainment, music, education, etc.), keywords, location, and IP address. The aforementioned features are extracted from desktop and mobile web devices. Examples of behavioral features associated with mobile app devices are apps, app categories, make and model of the mobile app device, time of the day, day of the week, location, and IP address.

Nowadays the devices used by a user are not restricted to a personal computer and a laptop that are devised as desktop web devices as shown in FIG. 1. Users perform many activities on alternative devices, such as smartphones, tablets, and smart televisions. For example, the user A may use the personal computer 104 at home for surfing the Internet. The user A has interest in football and in particular is a Chelsea fan. Thus, the personal computer 104 of the user A has a browser history filled with search results related to football, Chelsea, and Manchester United. As a football fan, the user A also plays FIFA online but uses the laptop 110 to do so. Further, the user A is an engineer working in the field of electronics and telecommunication and uses the tablet 106 to browse the Internet for work purpose and hence has a browsing history of electronic and telecommunication sites. The user A also accesses professional social websites such as LinkedIn™ on the tablet 106 to grow his professional network. The user A uses the smartphone 108 for personal use to access applications such as Whatsapp™ and Facebook™. Thus, the user A has varied activities across the personal computer 104, the tablet 106, the smartphone 108, and the laptop 110. In such a scenario, based on the behavioral features and activities, it is difficult to identify that the aforementioned devices are used by the same user. Especially in case of the smartphone 108 that the user A does not use to browse the Internet. It is difficult to track user activity on such a device and most importantly link the smartphone 108 to other desktop and mobile web devices. If the smartphone 108 is not linked to the desktop and mobile web devices, the user A does not receive advertisements and any updates related to football or electronics on the smartphone 108. Thus, a method to successfully link and identify a unique user across various device types is described herein.

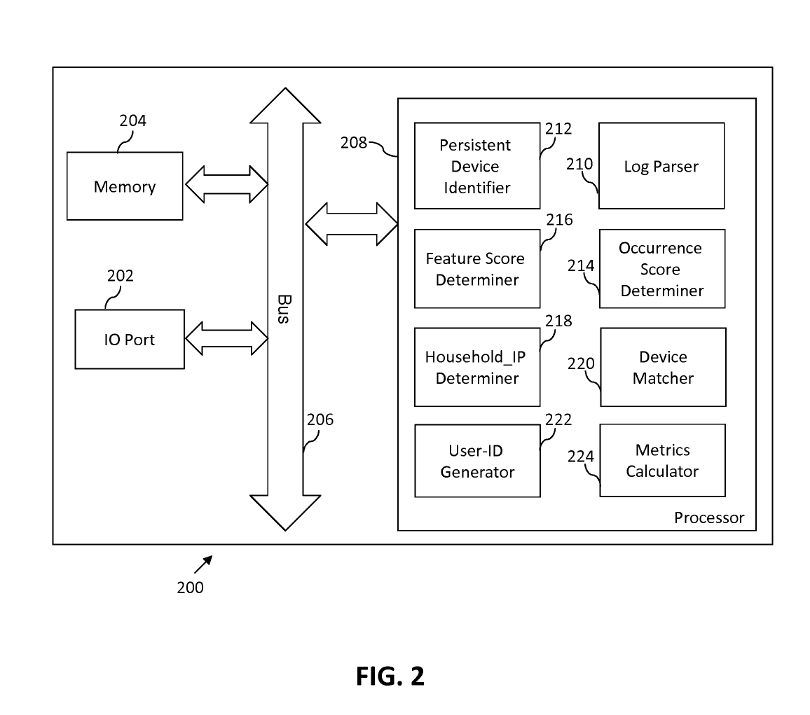

Referring now to FIG. 2, a schematic block diagram illustrating a computer system 200 for implementing various exemplary embodiments is shown. The computer system 200 includes instructions that are required to perform the methodologies described here. The computer system 200 may be implemented as a server machine or a client machine in a client-server computer network or a peer machine in a peer-to peer or distributed network. The computer system 200 may be realized in the form of a personal computer, a laptop, a server, a set-top box (STB), a tablet, a Personal Digital Assistant (PDA), a cellular telephone, a web appliance, a server, a network router, a network switch, a network bridge, a video game console, or any machine capable of executing a set of computer instructions (sequential or otherwise) to be executed by the computer system 200. Further, while only a single computer system 200 is illustrated, the term ‘computer system 200’ shall also be taken to include any collection of computer systems that individually or jointly execute a set (or multiple sets) of instructions to perform any one or more of the methodologies discussed herein.

The computer system 200 includes an input/output (IO) port 202, a memory 204, a system bus 206, and a processor 208. The processor 208 includes a log parser 210, a persistent device identifier 212, an occurrence score determiner 214, a feature score determiner 216, a household_IP determiner 218, a device matcher 220, a user-identification (ID) generator 222, and a metrics calculator 224. The log parser 210, the persistent device identifier 212, the occurrence score determiner 214, the feature score determiner 216, the household_IP determiner 218, the device matcher 220, the user-identification (ID) generator 222, and the metrics calculator 224 may include one or more components such as software components, object-oriented software components, class components and task components, processes, functions, attributes, procedures, subroutines, segments of program code, drivers, firmware, microcode, circuitry, data, databases, data structures, tables, arrays, and variables. The 10 port 202 is an interface between the computer system 200 and an external network, such as the Internet. The 10 port 202 may be connected to input devices such as keyboards, touch sensitive input devices, microphones, and so on to accept inputs from a user. Further, the 10 port 202 may be connected to an output device such as a display screen. The memory 204 stores sets of instructions to perform various functions described herein. The memory 204 may include any one or combination of volatile memory elements (e.g., random access memory (RAM, such as DRAM, SRAM, SDRAM, etc.)) and non-volatile memory elements (e.g., ROM, hard drive, tape, CDROM, etc.). Moreover, the memory 204 may incorporate electronic, magnetic, optical, and/or other types of storage media. The 10 port 202 and the memory 204 communicate by way of the system bus 206. The processor 208 fetches and executes the sets of instructions from the memory 204.

Computer network may include wired and wireless networks, such as the Internet, local area networks (LAN), metropolitan area networks (MAN), mobile networks and the like. In the exemplary embodiment of this specification, the computer network is the Internet. When an event occurs at a device in the computer network, the memory 204 stores device-specific and behavioral features associated with the event. The device may be a personal desktop, a laptop, a smartphone, and a tablet. The devices may include input devices such as keyboards, touch sensitive input devices, microphones, and so on to accept inputs from a user. The device-specific and behavioral features are inputs to the computer system 200. To identify a unique user of multiple devices, the log parser 210 extracts the device-specific features corresponding to the device associated with the event from the memory 204. The device-specific features are used to uniquely identify a device. The persistent device identifier 212 generates a device signature using these extracted device-specific features. The device-specific features may be combined in a number of ways to generate the device signature that is distinct for each device. For example, the user C performs an event of sharing an image using a widget on a social website such as Facebook™ on the laptop 124. Let the values of the device-specific features associated with the laptop 124 be as follows: browser type=Safari, OS type=OS X, browser fonts=abc1 (a hash of the full font string), browser plugins=abc2 (a hash of the full plugin string), screen resolution=abc3, time zone=abc4. Thus, the device signature is created from a hash of the combination of the aforementioned device-specific features and corresponding values. Thus, the device signature associated with the laptop 124 is hash (safariosxabc1abc2abc3abc4)=xyz. The device signature xyz is stored in event logs in the memory 204.

After device signatures corresponding to the devices in the network have been generated and stored in the memory 204, the log parser 210 extracts behavioral features associated with a device and an event from the memory 204. In an exemplary embodiment, the log parser 210 extracts all the behavioural features associated with the device and the event. In an alternate exemplary embodiment, the log parser 210 extracts one or more behavioural features associated with the device and the event. In the aforementioned example, feature values of the corresponding behavioral features associated with the laptop 124 are extracted and aggregated over time. For example, the counts of various domains the laptop 124 visits are aggregated over a period of time. Next, the feature score determiner 216 computes a score corresponding to the feature value. The behavioral features include:

Domains: The domains that the device has visited.
Social channels: The social channel is a social website that is used for professional, casual, or community service networking. Examples of social channels include Facebook™, LinkedIn™, etc.
Time of day: The hours of the day during which events occur at the device. The hour of the day is measured according to the local time zone of the device.
Day of the week: The days of the week during which events occur at the device.
Categories: Universal Resource Locators (URLs) are classified into a taxonomy of categories. Examples of categories are automobiles, sports, arts and entertainment, shopping, and the like. The taxonomy may be multi-level as well and may include sub-categories such as clothes, electronics, books, and so on under the category shopping. When the device visits the URLs, the device is associated with the categories of these URLs with corresponding scores.
Keywords: The URLs are analyzed and most important keywords from each URL are extracted. When the device visits the URLs, the device is associated with the keywords of the content associated with these URLs with corresponding scores.
Location: The location of the device may be determined at various levels of granularity from more precise latitude/longitude to higher level city, state and country. For US locations, the city/state locations are converted to DMA and where the DMA does not exist, the city and state are concatenated as the DMA. The DMA is one of the location features associated with the device.
IP address: The IP addresses at which events occur at the device are also used as a behavioral feature.

The feature values are stored in the memory 204. For example, when the feature is ‘domain’ for an event, the memory 204 includes the domain feature for each event. An individual feature value is not unique to a device. Further, different devices will have events occurring at the same domain. It is the combination of different feature values that helps in distinguishing devices for different users. Only one device signature is associated with an event. For example, when a user visits a web page from the browser Safari on a Mac, the Safari on the Mac is the ‘device’ and is the only device involved in the event.

The feature score determiner 216 aggregates the feature values and stores them in the memory 204. The aggregation is a summation of frequency counts of a feature across days for the device. For example, if a device has domain feature abc.com:5 (i.e. 5 visits to abc.com) on day 1, xyz.com:3 on day 2, and abc.com:7 on day 3 then the aggregated domain feature is abc.com:12|xyz.com:3 over the 3 days. In the aforementioned example, the aggregated score is a sum of individual scores. However, the aggregated score may be calculated using a smoothed scoring methodology.

Some of the scores for features such as social channel, category, time of the day, and day of the week are smoothed estimates of the feature frequencies. For example, if n_c is the number of times a device signature has accessed content in category c, a total frequency of the device signature across all categories is N, and there are C categories, the smoothed estimate score of the device signature for the category c is:

score=(1+n_c)/(N+C) (1)

The smoothed estimate score ensures that the feature value for a device signature that does not belong to a particular category is also a non-zero score. The non-zero score for all device signatures aids in comparing devices in the category feature by assigning some non-zero weights. However, scores for domains, keywords, IP and location may be non-smoothed estimate scores. For example, for the feature IP, the score is a ratio of the number of times a device signature occurs at an IP divided by the total number of times the device signature occurs across all IPs. The scores for domains, keywords, IP and location are non-smoothed estimate scores because the number of domains, keywords, IP, and locations each are large (i.e. C is much larger than N) and smoothed estimates do not work well for such large numbers.

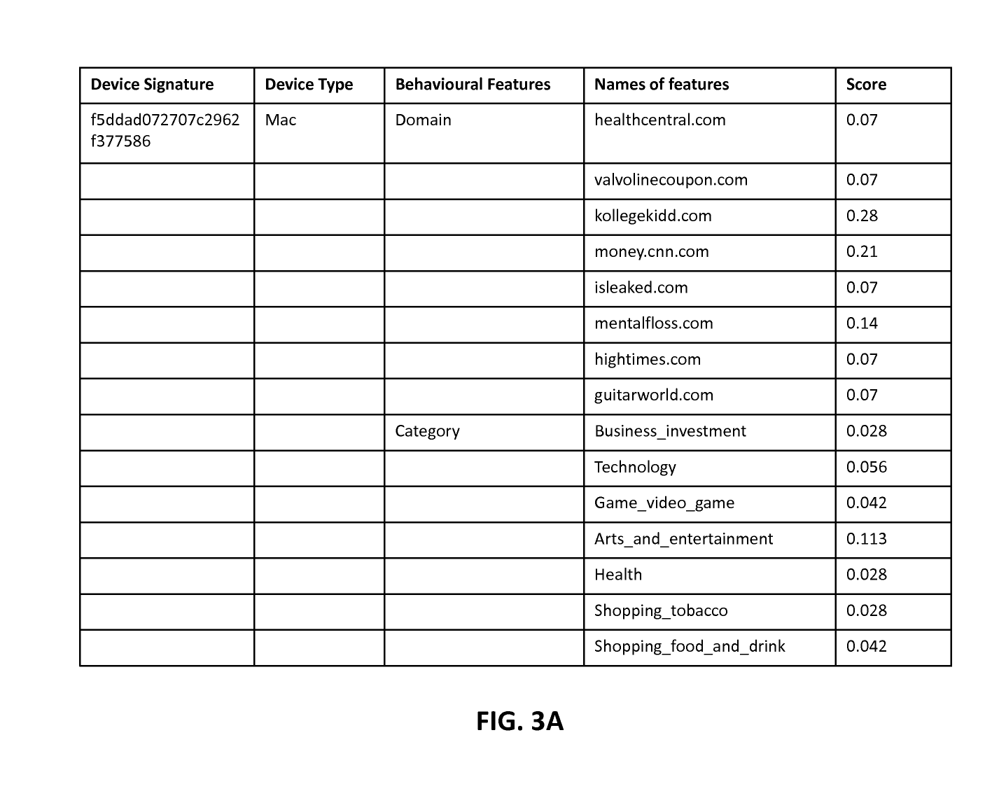

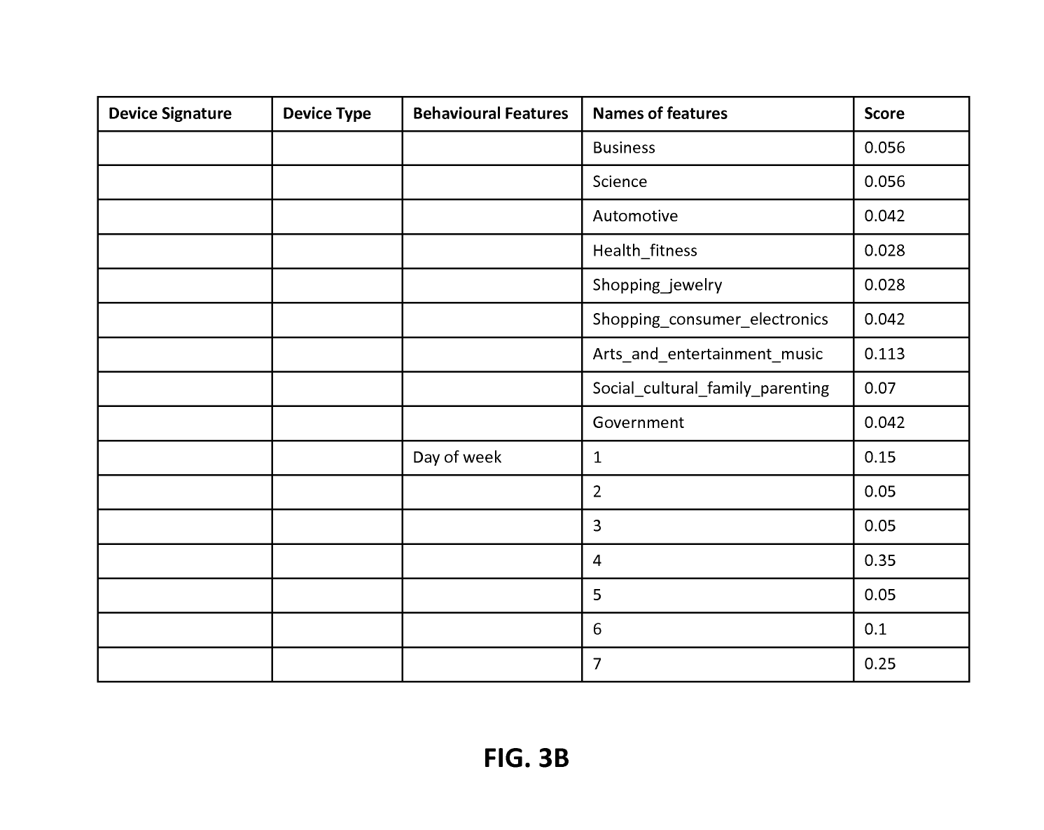

FIGS. 3A and 3B illustrate a table that represents a feature value map for a device, in accordance with an exemplary embodiment. The table includes the device signature (f5ddad072707c2962f377586) and the type (Mac) of the device. The table also includes a domain feature map i.e. a set of domains the device visited and each domain has a corresponding score. The table further includes a category feature map i.e. a set of categories and smoothed scores for each category and a feature map for day of the week. The day of the week features are from one to seven for the seven days of the week. From the feature value map, it is observed that the device visits the domains kollegekidd.com and mentalfloss.com the most. The device visits the category of arts and entertainment and in particular music under art and entertainment quite often. Further, the device is active more on day 4 (Wednesday) and day 7 (Saturday) than the other days of the week.

The log parser 210 extracts the behavioral features from various data sources such as ad exchanges and data logs from app stores for mobile app devices. The hardware mobile device IDs such as the IDFA or Android IDs for iOS™ and android mobile devices, respectively, are extracted and associated with the following features thereto: apps, app categories, make and model of the devices, time of the day, day of the week, location, and IP addresses.

For example, for an IDFA, the behavioral features have the following feature values:

### App: CNN app

### Category: News

Model: iPhone 6

### Time of day: 15:3, 20:2

Day of week: 6:5, 1:2

### Location: San Francisco, Calif.

### IP: 168.1.234.5

From the aforementioned feature values, it is understood that an iPhone 6 accessed the CNN app from an IP address 168.1.234.5 located in San Francisco, Calif. and was active at 3 pm and 8 pm on Saturday and Monday.

Thus, at the end of this step, the memory 204 has multiple device signatures and hardware mobile ids and their associated features with corresponding feature values. The device IDs are now linked to each other based on the device types. The occurrence score determiner 214 calculates an occurrence score (hereinafter referred to as “cross-IP score”). The cross-IP score is calculated between a desktop or a mobile web device type and a mobile app device type. A Bayesian formulation method is used to find the likelihood that a pair of desktop/mobile web device signature and a hardware mobile device ID (IDFA, Android ID) are related. The pair is identified by their presence in at least one common IP. Specifically, if a hardware mobile device ID ‘h’ and a desktop/mobile web device signature ‘s’ occurs together at an IP, this particular pair's cross-IP score would be calculated as follows:

If ‘a’ is the event that a desktop/mobile web device signature ‘s’ and a hardware mobile device ID ‘h’ are related, then the likelihood ‘P’ is computed by:

P(a|s,h)=P(s,h,a)/P(s,h)
where, P (s, h, a)=ΣP (s, h, a, IP)=ΣP (s, h|a, IP)×P (a, IP)=P (s, h|a, IP)×P (a|IP)×P (IP) P (s, h, [symbol] a)=ΣP (s, h| [symbol] a, IP)×P ( [symbol] a|IP)×P (IP) and P (s, h)=P (s, h, a)+P (s, h, [symbol] a)
   The summations are over all IPs. The probabilities are computed as:

P(IP)=Number of events at IP/Total number of all events at all IPs

P(a|IP)=1/(N_s×N_h)

where, N_s=Number of device signatures at the IP

N_h=Number of hardware mobile device IDs at the IP

P(s,h|a,IP)=(n_s+n_h)/Total number of all events at IP

P(s,h| [symbol] a,IP)=min(n_s,n_h)/Total number of all events at IP

where, n_s=number of events of device signature ‘s’ at IP

n_h=number of events of hardware mobile device ID ‘h’ at IP

The output from the occurrence score determiner 214 is a score P (a|s, h) that indicates how likely device signature ‘s’ and a hardware mobile device ID ‘h’ are for the same user given their observations across IPs.

After calculating the cross-IP score, the household_IP determiner 218 identifies sets of household IPs and non-household IPs. A household IP address is an IP address that is visited by at most a first predetermined number of hardware mobile device IDs and at most a second predetermined number of desktop or mobile web device signatures over a predetermined number of days. A non-household IP is an IP address that is visited by more than the first predetermined number of hardware mobile device IDs and more than the second predetermined number of desktop or mobile web device signatures over a predetermined number of days. In an exemplary embodiment, a household IP address is an IP address that is visited by at most 5 hardware mobile device IDs and at most 50 desktop or mobile web device signatures over a 60 day window.

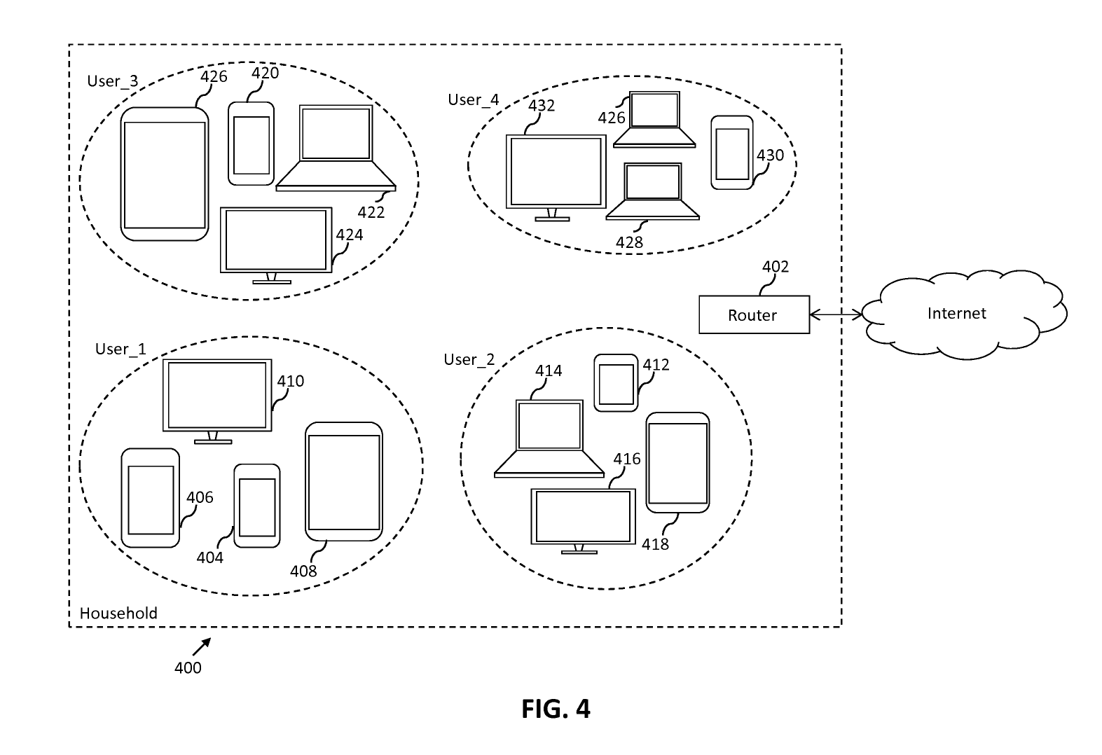

Referring now to FIG. 4, a schematic block diagram of a household 400 is shown. The household 400 is connected to the Internet by way of a router 402. Four individuals, user_1, user_2, user_3, and user_4 reside in the household 400. The user_1 owns smartphones 404 and 406, a tablet 408, and a personal computer 410. The user_2 uses a smartphone 412, a laptop 414, a personal computer 416, and a tablet 418. The user_3 uses a smartphone 420, a laptop 422, a personal computer 424, and a tablet 426. The user_4 uses laptops 426 and 428, a smartphone 430, and a personal computer 432. When the users_1-4 are in the household 400, their devices 404-432 are connected to the Internet by way of the router 402 and thus the devices 404-432 share the same IP address. The smartphones 404, 406, 412, 420, and 430 are identified by their respective hardware mobile device IDs. The personal computers 410, 416, 424, and 432, the tablets 408, 418, and 426, and the laptops 414, 422, 426, and 428 are identified by their respective device signatures. The smartphone 420 is identified by a device signature as well. The number of the hardware mobile device IDs and the device signatures accessing the Internet via the IP address of the router 402 is observed over a predetermined number of days. In the aforementioned example, over a 60 day window, it is observed that there are 5 hardware mobile device IDs and 12 device signatures accessing the Internet via the IP address of the router 402. The household_IP determiner 218 performs a check on the number of devices by using a threshold value i.e. a check is performed to determine whether the number of hardware mobile device IDs (in this case 5) is less than or equal to the threshold value of 5 and the number of device signatures (in this case 12) is less than or equal to the threshold value of 50. In this case, as the conditions are satisfied, the IP address of the router 402 is classified as a household IP.

Thus, to identify a unique user across multiple devices, the device signatures and the hardware mobile device IDs within the household IP only are compared to link the devices to each other. If the comparison of devices is not restricted to within the household IP, it results in a prohibitive comparison. Therefore, the comparison is broken down into a 2 step process where in step 1 device matching within each household IP is performed and then in step 2 the matches are carried over to non-household IPs and match any device that is yet unmatched in that IP.

Once household IPs and non-household IPs are identified, the device matcher 220 performs a series of comparisons to match devices for the same user. The device matcher 220 performs matching of different device types in distinct steps. First the device matcher 220 performs a mobile web device and a mobile app device matching for the same device type within a household. This is referred to as mobile web device signature to mobile hardware mobile device ID clustering. For example, in the household 400, the smartphones 404 and 420 are Samsung smartphones while the smartphones 406, 412, and 430 are iPhones which is indicated by their respective hardware mobile device IDs and device signatures. The hardware mobile device ID and the device signature associated with the smartphone 420 indicate that they represent similar devices i.e., Samsung. Hence, the hardware mobile device ID and the device signature associated with the smartphone 420 are compared and a similarity score is generated by using the formula:

sim(d1,d2)=w1×cross_IP_score(d1,d2)+w2×sim_time_of_day(d1,d2)+w3×sim_day_of_week(d1,d2)+w4×sim_location(d1,d2) (2)

where d1 is the hardware mobile device ID and d2 is the mobile web device signature associated with the smartphone 420. The cross-IP score is calculated in the preceding step and is described above.

The sim functions may be any of standard functions such as Jaccard or Cosine or may be a custom function to the feature. The sim_time_of_day function, for example, is a custom function which looks at an overlap on the same hour as well as neighboring hours to come up with a similarity score. For example, if an event occurs at the hardware mobile device ID d1 (smartphone 420) at hour 5 and an event occurs at the mobile web device signature d2 (smartphone 420) at hours 5 and 6, then both hours 5 and 6 for the mobile web device signature d2 are compared to hour 5 for the hardware mobile device ID d1 but hour 6 would get a lower weight. The weights w1, w2, w3, w4 for each feature are manually set or learned from the data. The similarity score is a value between 0 and 1 and is stored in the memory 204. The memory 204 also stores a similarity threshold value that determines whether a match has occurred or no. When the similarity score is greater than or equal to the similarity threshold value, the device matcher 220 matches the mobile web device signature d2 and the hardware mobile device ID d1 while when the similarity score is less than the similarity threshold value, the device matcher 220 does not match the mobile web device signature d2 and the hardware mobile device ID d1. In the example, the similarity threshold value is 0.7 and the similarity score between the hardware mobile device ID d1 and the mobile web device signature d2 for the smartphone 420 is 0.9. Thus, the similarity score is compared with the similarity threshold value and it is determined that the similarity score is greater than the similarity threshold value. Thus, the hardware mobile device ID d1 and the mobile web device signature d2 of the smartphone 420 are matched and it is determined that these are associated with the same device i.e. smartphone 420.

Next, the device matcher 220 performs a desktop web device to a mobile app device or mobile web device matching. This is referred to as desktop to mobile clustering. The desktop web device signatures are compared with the matched or unmatched mobile web device signature or mobile hardware mobile device IDs. Again, this step is performed for devices within the same household. A similarity score is define as:

sim(d,m)=w1×cross_IP_score(d,m)+w2×sim_domain(d,m)+w3×sim_category(d,m)+w4×sim_keyword(d,m)+w5×sim_social_channel(d,m)+w6×sim_location(d,m) (3)

where d=a desktop web device signature, and m=a device signature of the matched mobile app device to mobile web device pair or an unmatched hardware mobile device ID or an unmatched mobile web device signature. As described earlier, the sim functions are specific to the feature and can be implemented in various ways such as Cosine and Jaccard. The weights can be set manually or by learning from the data. The similarity score is a value between 0 and 1 and is stored in the memory 204. The memory 204 also stores a similarity threshold value that determines whether a match has occurred or not. When the similarity score is greater than or equal to the similarity threshold value, the device matcher 220 matches the desktop web device signature to the device signature of the matched mobile app device to mobile web device pair or an unmatched hardware mobile device ID or an unmatched mobile web device signature. When the similarity score is less than the similarity threshold value, the device matcher 220 does not match the desktop web device signature to the device signature of the matched mobile app device to mobile web device pair or an unmatched hardware mobile device ID or an unmatched mobile web device signature.

In the next step, different mobile web and app devices are compared against each other within the same household IP. However, in contrast to the mobile web device signature to mobile hardware mobile device ID clustering, in this step the device matcher 220 does not perform the matching for similar models of the mobile web and app devices. The purpose of this step is to perform matching between different mobile device types so as to determine the mobile web and app devices that belong to a single user. For example, the device signatures of the tablet 426 and the smartphone 420 are compared and a similarity score is generated in a similar manner. This is referred to as mobile to mobile clustering, which uses the behavioral features to perform matching. Along with behavioral features such as domains, categories, and the like, features such as apps and app categories are also used. The features such as apps and app categories are used to determine matching between different mobile app devices, for example, between a hardware mobile device ID for a tablet app device and a hardware mobile device ID for a mobile app device. It is to be noted that this mobile to mobile clustering is again performed within a household.

In the last step, the device matcher 220 matches devices associated with non-household IPs to each other. After the devices within the household 400 are matched, the device matcher 220 performs matching of devices outside the household 400. For a non-household IP, the matched devices are segregated from the unmatched ones. These unmatched devices are the devices that were identified in the preceding steps. For example, consider for a household IP 101.2.3.4, device signatures/hardware mobile device IDs, D1 and D2 have been matched. Device signatures/hardware mobile device IDs D2, D4 and D6 belong to a non-household IP 101.4.5.6. It is determined that the device signatures/hardware mobile device ID D2 has been matched earlier. Thus, the device signatures/hardware mobile device IDs D4 and D6 are separated out and matched by repeating the steps of matching performed within the household. This helps in reducing the space of possible matches to be considered in non-household IPs and makes the computation feasible.

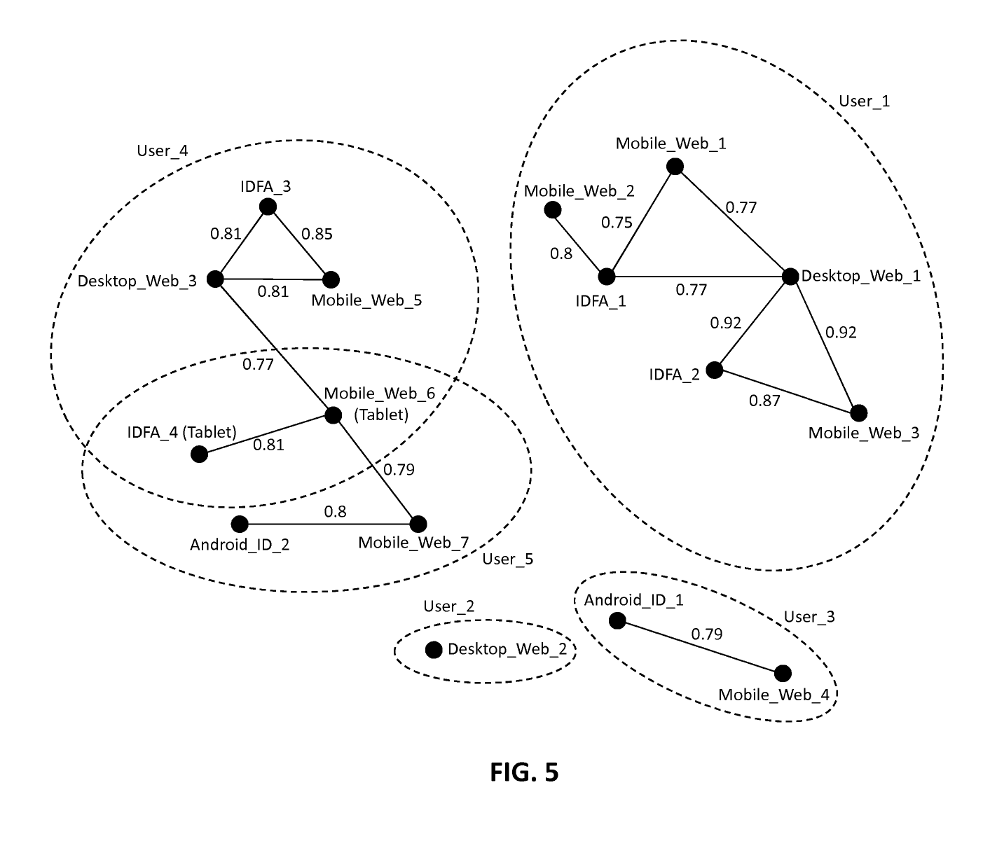

When all the devices are linked to each other by way of similarity scores, the user-ID generator 222 generates a device graph and creates user IDs therefrom. At the end of all the matching steps, various devices are connected to each other and for each of these connections there is a similarity score. These device connections are represented in the form of a device graph. In the device graph, each node represents a unique device and there are edges between pairs of nodes when the corresponding devices have been matched. Such a device graph is displayed on the display screen. An example device graph is shown in FIG. 5.

In FIG. 5 there are multiple devices connected to each other. There are 3 desktop web devices, 7 mobile web devices, 3 mobile app (IDFA-phone) devices, 2 mobile app (Android ID-phone) devices, and 1 mobile app (IDFA-tablet) device. The weights on the edges represent the similarity scores or device association scores. The users are represented by dashed lines. In the FIG. 5, user_1 has 2 mobile app (IDFA-phone) devices (IDFA_1 and IDFA_2), 3 mobile web devices (mobile_web_1, mobile_web_2, and mobile_web_3), and 1 desktop web device (desktop_web_1). User_2 on the other hand has only one desktop web device (desktop_web_2). User_3 has a mobile app (Android ID-phone) device (Android_ID_1) connected to a mobile web device (mobile_web_4). User_4 has a desktop web device (desktop_web_3), a mobile web device (mobile_web_5), and a mobile app (IDFA-phone) device (IDFA_3). User_5 has a mobile app (Android ID-phone) device (Android_ID_2) connected to a mobile web device (mobile_web_7). Further, user_4 and user_5 share the tablet devices IDFA_4 and mobile web 6.

Users are created from the device graph with a variation in a connected component graph algorithm. The connected component graph algorithm finds all nodes in the graph such that there is a path between any pair of nodes. It is well known in the art that a component in context of the connected component graph algorithm is defined as a subgraph that includes any two nodes connected to each other by way of edges. To handle shared devices (nodes) in the graph, the connected component algorithm is modified. The modification is necessary since otherwise, the user_4 and the user_5 would be merged together. The modified connected component algorithm performs the following steps:

1. Builds a connected component using non-tablet device nodes.
2. Adds a node to an existing connected component if and only if:
a) there is an edge from the component to the node, and
b) if it is a non-tablet node, then it is not connected to the component via tablet device nodes only. With this modification, the user_4 and the user_5 are not merged into a single user.

At the end of the execution of the connected component graph algorithm, there is a collection of device IDs in each component. The user-ID generator 222 generates a unique user ID from each component. The following steps are performed in sequence to generate a user ID from each component:

1. If there is only one hardware mobile device ID in the component, then a hash of the hardware mobile device ID of the mobile phone is the user ID, else
2. If there are multiple hardware mobile device IDs in the component, then a hash of the hardware mobile device ID with maximum number of events is the user ID, else
3. If there is only one device signature associated with a mobile web device in the component, then a hash of the device signature associated with the mobile web device is the user ID, else
4. If there are multiple device signatures associated with mobile web devices in the component, then a hash of the device signature with maximum number of events is the user ID, else
5. If there are no mobile web or app devices in the component, then a hash of a desktop web device signature with maximum number of events is the user ID.

In another exemplary embodiment, the metrics calculator 224 measures the performance of the user-ID generator 222 by way of four metrics, the four metrics being coverage, churn, accuracy, and collision. The metrics calculator 224 uses the coverage metric to determine the number of events performed in the computer network by users identified by the user-ID generator 222. The coverage metric determines how extensive the aforementioned clustering process is. The coverage metric is observed over a period of time, for example 30 days. Let N=total number of events, D=total number of unique devices, U=total number of users created from the user identification process, N_u=total number of events from these U users, then the coverage is determined by N_u/N. It is desirable to have a high coverage such that the user IDs generated by the user-ID generator 222 subsume maximum number of events in the computer network.

The churn metric determines whether the same user ID occurs at more than two time instances. At time instances T1 and T2, let the number of users be N1 and N2, respectively. Thus, the churn is calculated as 1−(N1∩N2)/N2. It is desirable to have a low churn as it is not reasonable to create new users for different time periods.

The accuracy metric measures the accuracy of identifying unique users. The accuracy metric is defined in terms of ‘long lived cookies’ that are stable and have been in existence for a period of time. A long lived cookie is associated with a single browser and typically for a single user. The accuracy metric measures instances where a single long-lived cookie is mapped to multiple users. Let N_I be the number of long-lived cookies mapped to users and N_I_m be the number of long-lived cookies mapped to multiple users, then, the accuracy is defined as 1−N_I_m/N_I. It is desirable to have a high accuracy to reflect unique mapping of long lived cookies to users.

The collision metric measures instances of different long lived cookies being mapped to the same user. Let N_u be the number of users mapped to long-lived cookies and N_u_m be the number of users mapped to multiple long lived cookies, then, the collision is defined as N_u_m/N_u. A high degree of collision indicates erroneous mapping of the long lived cookies and the users. Hence, it is desirable to have low collision. The four metrics are used independently to measure the effectiveness of the aforementioned process of generating unique user-IDs.

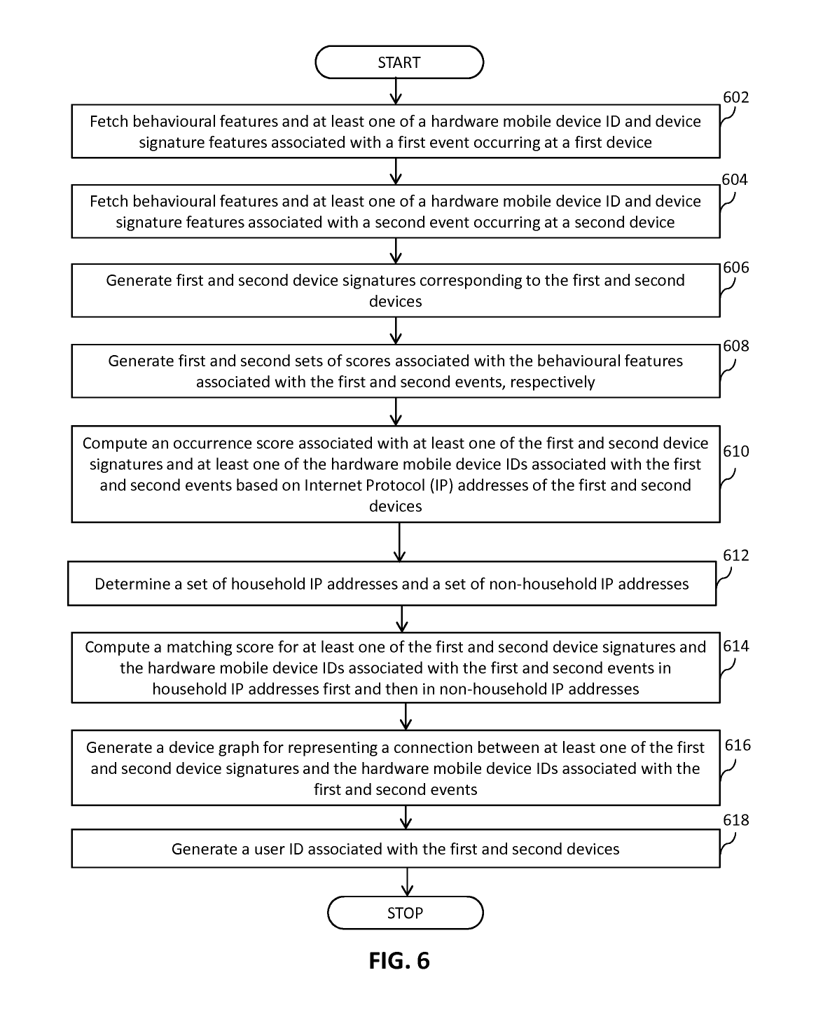

Referring now to FIG. 6, a flow chart illustrating a method of identifying a unique user across multiple devices is shown in accordance with an exemplary embodiment. At operation S602, the log parser 210 fetches behavioral features and at least one of a hardware mobile device ID and device signature features associated with a first event occurring at a first device. At operation S604, the log parser 210 fetches behavioral features and at least one of a hardware mobile device ID and device signature features associated with a second event occurring at a second device. It should be noted that the log parser 210 may perform operation S602 and operation S604 simultaneously. At operation S606, the persistent device identifier 212 generates first and second device signatures corresponding to the first and second devices. At operation S608, the feature score determiner 216 generates first and second sets of scores associated with the behavioral features associated with the first and second events, respectively. At operation S610, the occurrence score determiner 214 computes an occurrence score associated with at least one of the first and second device signatures and at least one of the hardware mobile device IDs associated with the first and second events based on the IP addresses of the first and second devices. At operation S612, the household_IP determiner 218 determines a set of household IP addresses. At operation S614, the device matcher 220 computes a matching score for at least one of the first and second device signatures and the hardware mobile device IDs associated with the first and second events. At operation S616, the user-ID generator 222 generates a device graph for representing a connection between at least one of the first and second device signatures and the hardware mobile device IDs associated with the first and second events. At operation S618, the user-ID generator 222 generates a user ID associated with the first and second devices.

Similarly, the user-ID generator 222 generates multiple such unique user IDs associated with corresponding multiple devices. The unique user IDs are of great importance to online advertisers as the advertisers provide ads to users based on their online behavioral pattern. Online advertising involves publishers and advertisers. A publisher is an entity that displays advertisements (ads) on its website. An advertiser is an entity that provides ads to be displayed on the publisher's website. Online advertising includes electronic mails (emails), search engine marketing, display advertising, and mobile advertising. Display advertising uses text, logos, pictures, videos, and the like to advertise on a website. An online advertising architecture further includes ad exchanges and real-time bidding (RTB) servers. Ad exchanges, such as AdECN, Doubleclick and RightMedia are online platforms that facilitate bidded buying and selling of advertisements from multiple ad networks. RTB servers facilitate real-time bidding through which ad inventory is bought or sold via programmatic auction. Advertisers have advertising campaigns running on various publisher websites accessed by users through multiple devices. Ads are served as impressions on these publisher websites to the target audience segment. With real time bidding, ad buyers bid based on impressions, and if the bid is successfully won, the ad is instantaneously displayed on the publisher website.

Display advertisers often track a user's activity on the Internet to target ads to the most potential user. This is referred to as ‘targeted advertising’. As each user ID is associated with corresponding multiple devices, advertisers track user activities corresponding to the user IDs across all their respective multiple devices. Thus, the advertisers generate a richer behavioural pattern of individual users. The advertisers use the behavioural pattern of users to provide relevant advertisements thereto and to generate audience segments with common interests. Further, the advertisers leverage the fact that a unique user ID is associated with multiple devices and provide the relevant advertisements on all the multiple devices associated with the user ID.

Various exemplary embodiments offer the following advantages: The method for identifying a unique user across multiple devices accurately identifies a unique user across all device types. The method and system achieve better targeting of online advertisements to potential customers.

In general, the various exemplary embodiments may be implemented in hardware or special purpose circuits, software, logic, or any combination thereof. For example, some aspects may be implemented in hardware, while other aspects may be implemented in firmware or software which may be executed by a processor, such as a controller, microprocessor or other computing device, although the exemplary embodiments are not limited thereto. While various aspects of the exemplary embodiments may be illustrated and described as block diagrams or flow charts, it will be understood that these blocks, apparatus, systems, techniques or methods described herein may be implemented in, as non-limiting examples, hardware, software, firmware, special purpose circuits or logic, general purpose hardware or controller or other computing devices, or some combination thereof.

Thus, the inventive concepts have been described herein with reference to a particular exemplary embodiment for a particular application. Although selected exemplary embodiments have been illustrated and described in detail, it may be understood that various substitutions and alterations are possible. Those having ordinary skill in the art and access to the present teachings may recognize additional various substitutions and alterations are also possible without departing from the spirit and scope, and as defined by the following claims.

What is claimed is:

1. An apparatus for identifying a user associated with a first and a second device of a plurality of devices in a network, the system comprising:
a memory configured to store behavioral features and at least one of a hardware identification (ID) and device signature features associated with a first event occurring at the first device, and behavioral features and at least one of a hardware ID and device signature features associated with a second event occurring at the second device;
a processor which is connected to the memory and includes:
a log parser configured to fetch the behavioral features and at least one of the hardware ID and the device signature features associated with the first event occurring at the first device, and the behavioral features and at least one of the hardware ID and the device signature features associated with the second event occurring at the second device;
a persistent device identifier configured to generate first and second device signatures respectively corresponding to the first and second devices based on the device signature features associated with the first and second events, respectively;
a feature score determiner configured to fetch the behavioral features associated with the first and second events and generate first and second sets of scores, respectively;
an occurrence score determiner configured to determine an occurrence score associated with at least one of the first and second device signatures and at least one of the hardware IDs associated with the first and second events based on Internet Protocol (IP) addresses of the first and second devices;
a household_IP determiner configured to determine the set of household IP addresses and the set of non-household IP addresses;
a device matcher configured to determine a matching score for at least one of the first and second device signatures and the hardware IDs associated with the first and second events based on the occurrence score and the behavioral features associated with the first and second events; and
a user-ID generator configured to generate a device graph for representing a connection between at least one of the first and second device signatures and the hardware IDs associated with the first and second events based on the matching score, and generating a user ID associated with the first and second devices based on the connection therebetween, thereby associating the first and second devices with the user, wherein the user ID is stored in the memory.

2. The apparatus of claim 1, wherein the event comprises at least one of social and non-social sharing activities, social and non-social page-view activities, and social and non-social page-landing activities.

3. The apparatus of claim 1, wherein the device signature features include at least one of a browser type, an operating system type, a browser font, a browser plugin, a screen resolution, a geographic location, the IP address, and a browser time zone.

4. The apparatus of claim 1, wherein the persistent device identifier further generates a first concatenated string based on the device signature features associated with the first event and a second concatenated string based on the device signature features associated with the second event, applies a hash function to the first and second concatenated strings, and generates first and second hashed concatenated strings based on the first and second concatenated strings, respectively, and wherein the first and second hashed concatenated strings represent the first and second device signatures, respectively.

5. The apparatus of claim 1, wherein the behavioral features include at least one of a domain, a social channel, a time of day, a day of week, a category, a keyword, a geographic location, an application program, an application program category, and the IP address.

6. The apparatus of claim 1, wherein the occurrence score determiner further calculates the occurrence score by applying Bayesian formula to the first and second device signatures, the hardware IDs associated with the first and second events, and the IP addresses.

7. The apparatus of claim 1, wherein the IP address represents a household IP when the household_IP determiner determines that at least one of the first and second device signatures and the hardware IDs associated with the first and second events are associated with the IP address, a number of device signatures is less than a first predetermined number of device signatures, and a number of hardware IDs is less than a second predetermined number of hardware IDs.

8. The apparatus of claim 1, wherein the device matcher further associates a set of weights and an occurrence weight with the behavioral features associated with the first and second events and the occurrence score, respectively, for calculating the matching score.

9. The apparatus of claim 1, wherein the device matcher computes the matching score based on a first device type and a second device type of the first and second devices, respectively, and wherein the first and second device types include one of a desktop web device, a mobile web device, and a mobile application device.

10. The apparatus of claim 1, wherein the user-ID generator further applies a hash function to at least one of the first and second device signatures and hardware IDs associated with the first and second events, generates at least one of hashed first and second device signatures and hashed hardware IDs associated with the first and second events, and generates the user ID associated with the user based on at least one of the hashed first and second device signatures and hardware IDs associated with the first and second events.

11. A method for identifying a user associated with a first and a second device of the plurality of devices in a network, the method comprising:
fetching behavioral features and at least one of a hardware ID and device signature features associated with a first event occurring at a first device, and behavioral features and at least one of a hardware ID and device signature features associated with a second event occurring at a second device;
generating first and second device signatures corresponding to the first and second devices based on the device signature features associated with the first and second events, respectively;
fetching the behavioral features associated with the first and second events;
generating first and second sets of scores corresponding to the behavioral features associated with the first and second events, respectively;
computing an occurrence score associated with at least one of the first and second device signatures and at least one of the hardware IDs associated with the first and second events based on Internet Protocol (IP) addresses of the first and second devices;
determining whether at least one of the first and second device signatures and the hardware IDs associated with the first and second events are associated with an IP address;
computing a matching score for at least one of the first and second device signatures and the hardware IDs associated with the first and second events based on the occurrence score and the behavioral features associated with the first and second events;
generating a device graph for representing a connection between at least one of the first and second device signatures and the hardware IDs associated with the first and second events based on the matching score; and
generating a user ID associated with the first and second devices based on the connection therebetween, thereby associating the first and second devices with the user.

12. The method of claim 11, wherein the event comprises at least one of social and non-social sharing activities, social and non-social page-view activities, and social and non-social page-landing activities.

13. The method of claim 11, wherein the device signature features include at least one of a browser type, an operating system type, a browser font, a browser plugin, a screen resolution, a geographic location, the IP address, and a browser time zone.

14. The method of claim 11, wherein the step of generating the first and second device signatures includes:
generating a first concatenated string based on the device signature features associated with the first event and a second concatenated string based on the device signature features associated with the second event;
applying a hash function to the first and second concatenated strings; and
generating first and second hashed concatenated strings based on the first and second concatenated strings, respectively, and wherein the first and second hashed concatenated strings represent the first and second device signatures, respectively.

15. The method of claim 11, wherein the behavioral features include at least one of a domain, a social channel, a time of day, a day of week, a category, a keyword, a geographic location, an application program, an application program category, and the IP address.

16. The method of claim 11, wherein the step of generating the occurrence score includes calculating the occurrence score by applying Bayesian formula to the first and second device signatures, the hardware IDs associated with the first and second events, and the IP addresses.

17. The method of claim 11, wherein the IP address represents a household IP when at least one of the first and second device signatures and the hardware IDs associated with the first and second events are associated with the IP address, a number of device signatures is less than a first predetermined number of device signatures, and a number of hardware IDs is less than a second predetermined number of hardware IDs.

18. The method of claim 11, wherein a set of weights and an occurrence weight are associated with the behavioral of features associated with the first and second events and the occurrence score, respectively, for calculating the matching score.

19. The method of claim 11, wherein the determining the matching score is performed based on a first device type and a second device type of the first and second devices, respectively, and wherein the first and second device types include one of a desktop web device, a mobile web device, and a mobile application device.

20. The method of claim 11, wherein the generating the user ID includes:
applying a hash function to at least one of the first and second device signatures and hardware IDs associated with the first and second events;
generating at least one of hashed first and second device signatures and hardware IDs associated with the first and second events; and
generating the user ID associated with the user based on at least one of the hashed first and second device signatures and hardware IDs associated with the first and second events.
